(19) United States
(12) Patent Application Publication
(10) Pub. No.: US 2009/0248987 A1
(43) Pub. Date: Oct. 1, 2009

(54) Memory System and Data Storing Method Thereof

(76) Inventors: Myoungsoo Jung, Suwon-Si (KR); Sung-Chul Kim, Hwaseong-si (KR); Chan-Ik Park, Seoul (KR); Se-Jeong Jang, Yongin-si (KR)

Correspondence Address: F. CHAU & ASSOCIATES, LLC, 130 WOODBURY ROAD, WOODBURY, NY, 11797, US

(21) Appl. No.: 12/411,094

(22) Filed: Mar. 25, 2009

(30) Foreign Application Priority Data
Mar. 25, 2008 (KR) 2008-27480

(51) Int. Cl. G06F 13/00; G06F 12/00; G06F 12/08

(52) U.S. Cl. 711/135; 711/165; 707/204; 711/E12.001; 711/E12.022

(57) ABSTRACT

A memory system includes a memory device having a cache area and a main area, and a memory controller configured to control the memory device, wherein the memory controller is configured to dump file data into the cache area in response to a flush cache command.

### CROSS-REFERENCE TO RELATED APPLICATIONS

This U.S. non-provisional patent application claims priority under 35 U.S.C. § 119 of Korean Patent Application No. 10-2008-0027480 filed on Mar. 25, 2008, the entirety of which is hereby incorporated by reference.

### BACKGROUND

1) Technical Field

The present invention relates to a memory system. More particularly, the present invention relates to a memory system having a Solid State Disk (SSD) and a data storing method thereof.

2) Discussion of Related Art

Computer systems use various types of memory systems. For example, computer systems use main memory, cache memory, etc., comprising semiconductor devices.

Such semiconductor devices may be written or read randomly, and are typically called Random Access Memory (RAM). Since semiconductor devices are relatively expensive, other, less expensive, high-density memories may be used.

For example, these other memory systems may include magnetic disk storage systems or disk storage devices. An access speed of the magnetic disk stage systems is several-ten milliseconds while an access speed of the main memory is several hundreds nanoseconds. Disk storage devices may be used to store mass data that is sequentially read from a main memory.

A Solid State Drive (SSD) (or, referred to as a solid state disk) is another storage device. To store data, the SSD uses memory chips such as SDRAM instead of a rotary disk used in a typical hard disk drive.

The term SSD may be used for two different products. A first type of SSD is based on a high-speed and volatile memory such as SDRAM and may be characterized by a relatively fast data access speed. The first type of SSD is typically used to improve application speed that may be delayed due to latency of a disk drive. Since the SSD uses volatile memories, it may include an internal battery and a backup disk system to secure data consistency.

If a power supply is suddenly turned off, the SSD is powered by a battery during a time sufficient to copy data in RAM into a backup disk. As a power supply is turned on, data in the backup disk is again copied into the RAM, so that the SSD resumes a normal operation. The above-described SSD may be useful for a computer that uses large-volume RAM.

A second type of SSD may use flash memories to store data. The second type of SSD may be used to replace a hard disk drive. To distinguish the first type of SSD, the second type of SSD is typically called a solid state disk.

A memory system having a conventional solid state disk may include a buffer memory or a cache memory in a memory controller to improve its performance. Further, a conventional memory system may use Flash Translation Layer (FTL) to write sequential file data in a cache memory to the solid state disk randomly.

When a flush cache command is received, a memory system having a conventional SSD may store file data of a cache memory into SSD to retain data consistency. At this time, data stored in the cache memory is sequential data, but may become misaligned to flash memory addresses of the SSD. For this reason, data to be written in one page of a flash memory is divided into two pages and is written in the two divided pages. This may reduce write performance of the SSD and result in wasted storage space of the flash memory.

### SUMMARY OF THE INVENTION

According to an exemplary embodiment of the present invention a memory system comprises a memory device having a cache area and a main area, and a memory controller configured to control the memory device, wherein the memory controller is configured to dump file data into the cache area in response to a flush cache command.

According to an exemplary embodiment of the present invention a data storing method of a memory system which comprises a memory device having a cache area and a main area and a memory controller configured to control the memory device comprises dumping file data into the cache area of the memory device in response to a flush cache command, and moving the file data of the cache area into the main area.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a schematic block diagram showing a memory system according to an exemplary embodiment of the present invention.

FIG. 2 is a block diagram showing a cache scheme of a memory system in FIG. 1.

FIG. 3 is a block diagram showing a cache scheme using cache translation layer of a memory system in FIG. 1.

FIG. 4 is a conceptual diagram showing data migration at a cache scheme in FIG. 3.

FIG. 5 is a flow chart for describing an operation of a memory system according to an exemplary embodiment of the present invention.

FIG. 6 is a schematic block diagram showing a computing system including a solid state disk according to an exemplary embodiment of the present invention.

### DETAILED DESCRIPTION OF EXEMPLARY EMBODIMENTS

Exemplary embodiments of the present invention will be described below in more detail with reference to the accompanying drawings, showing a flash memory device as an example for illustrating structural and operational features by the invention. The present invention may, however, be embodied in different forms and should not be constructed as limited to the embodiments set forth herein. Rather, embodiments are provided so that this disclosure will be thorough and complete, and will fully convey the scope of the present invention to those skilled in the art. Like reference numerals refer to like elements throughout the accompanying figures.

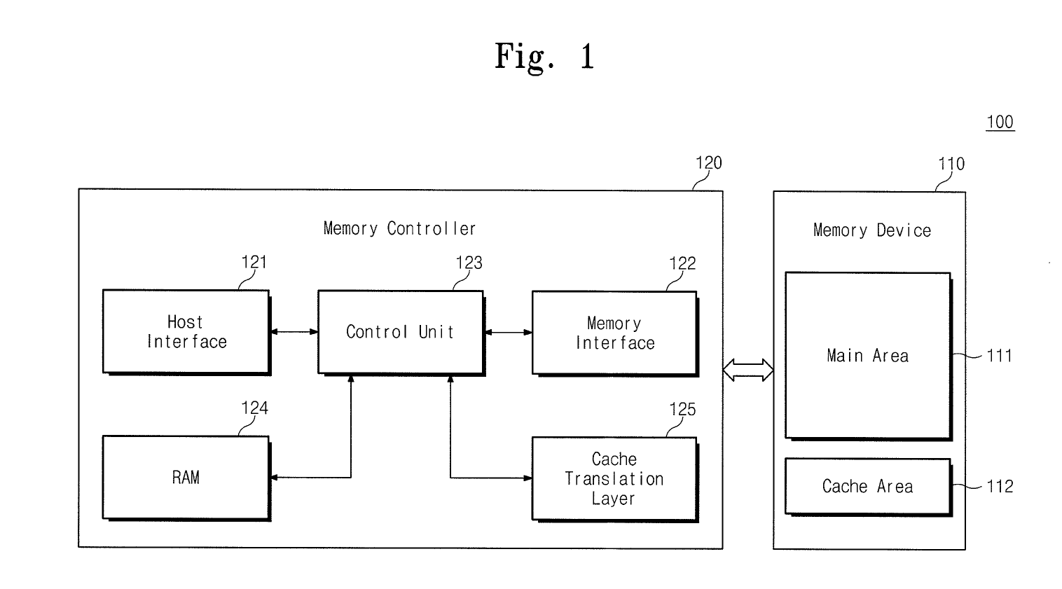

FIG. 1 is a schematic block diagram showing a memory system according to an exemplary embodiment of the present invention. Referring to FIG. 1, a memory system 100 according to an exemplary embodiment of the present invention may include a memory device 110 and a memory controller 120.

The memory device 110 may be controlled by the memory controller 120 and perform an operation (e.g., read, erase, program, and merge operations) corresponding to a request of the memory controller 120. The memory device 110 may include a main area 111 and a cache area 112. The main and cache areas 111 and 112 may be embodied in one memory device or separate memory devices.

For example, the main area 111 may be embodied in a memory performing a low-speed operation, wherein the main area 111 is a low-speed non-volatile memory. The cache area 112 may be embodied in a memory performing a high-speed operation, wherein the cache area 112 is a high-speed non-volatile memory. The high-speed non-volatile memory may be configured to use a mapping scheme suitable for a high speed, and the low-speed non-volatile memory may be configured to use a mapping scheme suitable for a low speed.

For example, the main area 111 being the low-speed non-volatile memory may be managed by a block mapping scheme, and the cache area 112 being the high-speed non-volatile memory may be managed by a page mapping scheme. The page mapping scheme does not necessitate a merge operation, which may reduce operating performance (e.g., write performance), so that the cache area 112 managed by the page mapping scheme provides high-speed operational performance. The block mapping scheme necessitates the merge operation, so that the main area 111 managed by the block mapping scheme provides low-speed operational performance.

The cache area 112 comprises a plurality of memory cells and may be configured by a single-level flash memory capable of storing 1-bit data (single-bit) per cell. The main area 111 comprises a plurality of memory cells and may be configured by a multi-level flash memory capable of storing N-bit data (multi-bit data, where N is an integer greater than 1) per cell. Alternatively, the main and cache areas 111 and 112 may be configured by a multi-level flash memory, respectively. In this case, a multi-level flash memory of the main area 111 may perform an LSB (Least Significant Bit) operation so as to operate as a single-level flash memory. Alternatively, the main and cache areas 111 and 112 may be configured by a single-level flash memory, respectively.

The memory controller 120 may control read and write operations of the memory device 110 in response to a request of an external device (e.g., host). The memory controller 120 may include a host interface 121, a memory interface 122, a control unit 123, RAM 124, and a cache translation layer 125.

The host interface 121 may provide an interface with the external device (e.g., host), and the memory interface 122 may provide an interface with the memory device 110. The host interface 121 may be connected with a host (not shown) via one or more channels or ports. For example, the host interface 121 may be connected with a host via one of two channels, that is, a Parallel AT Attachment (PATA) bus or a Serial ATA (SATA) bus. Alternatively, the host interface 121 may be connected with a host via the PATA and SATA buses. Alternatively, the host interface 121 may be connected with the external device via another interface, e.g., SCSI (Small Computer System Interface), USB (Universal Serial Bus), and the like.

The control unit 123 may control an operation (e.g., reading, erasing, file system managing, etc.) of the memory device 110. For example, although not shown in figures, the control unit 123 may include CPU/processor, SRAM (Static RAM), DMA (Direct Memory Access) controller, ECC (Error Control Coding) engine, and the like. An example of the control unit 123 is disclosed in U.S. Patent publication No. 2006-0152981 entitled “Solid State Disk controller Apparatus”, the contents of which are herein incorporated by reference.

The RAM 124 may operate responsive to the control of the control unit 123, and may be used as a working memory, a flash translation layer (FTL), a buffer memory, a cache memory, and the like. The RAM 124 may be embodied by one chip or a plurality of chips each corresponding to the working memory, the flash translation layer (FTL), the buffer memory, the cache memory, and the like.

In the case that the RAM 124 is used as a working memory, data processed by the control unit 123 may be temporarily stored in the RAM 124. If the memory device 110 is a flash memory, the FTL may be used to manage a merge operation or a mapping table of the flash memory. If the RAM 124 is used as a buffer memory, it may be used to buffer data to be transferred from a host to the memory device 110 or from the memory device 110 to the host. In the case that the RAM 124 is used as a cache memory, it enables the memory device 110 of a low speed to operate in a high speed.

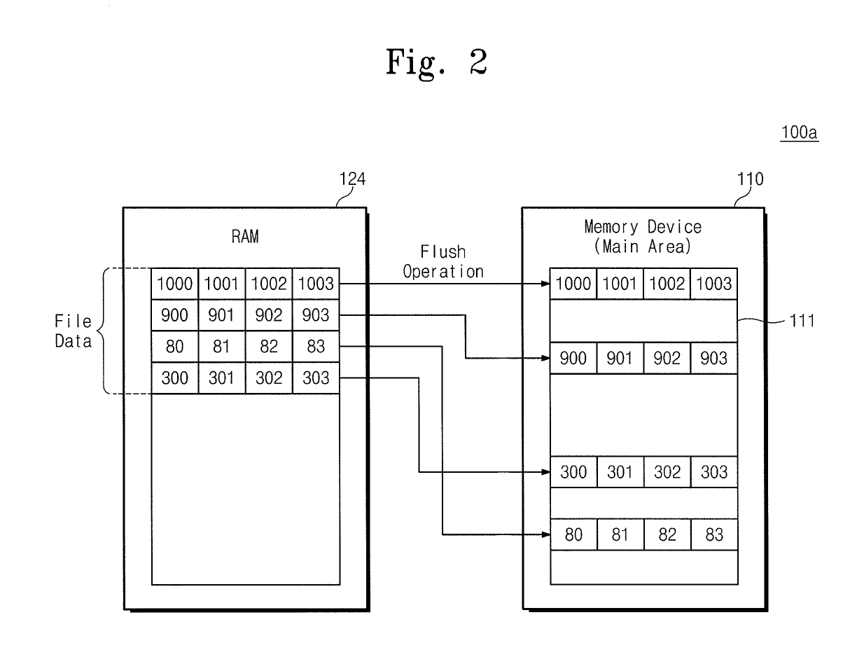

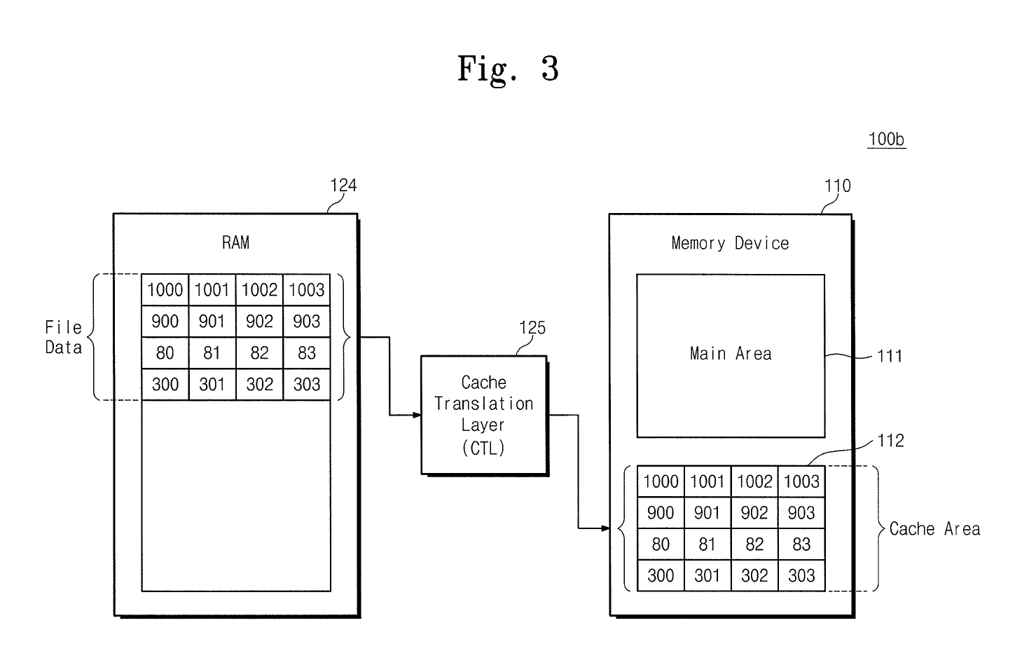

The cache translation layer (CTL) 125 may be provided to complement a scheme using a cache memory, which is called a cache scheme hereinafter. The cache scheme will be described with reference to FIG. 2. The CTL 125 may dump file data in a cache memory into the cache area 112 of the memory device 110 and manage a cache mapping table associated with the dumping operation, which will be more fully described with reference to FIG. 3.

FIGS. 2 and 3 are block diagrams showing cache schemes of a memory system in FIG. 1. In particular, FIG. 2 is a block diagram showing a cache scheme of a memory system in FIG. 1, and FIG. 3 is a block diagram showing a cache scheme using cache translation layer of a memory system in FIG. 1.

Referring to FIG. 2, a cache memory 124 may store file data at a continuous address space. In FIG. 2, 1000 to 1003, 900 to 903, 80 to 83, and 300 to 303 indicate physical addresses of a main area 111 of a memory device 110. For example, data marked by 1000 may be stored at a physical address 1000 of the main area 111 of the memory device 110.

A host (not shown) may provide a memory system 100 (refer to FIG. 1) with commands for write and read operations, and a command for a flush cache operation. If a flush cache command is input, the memory system 100 may store file data of the cache memory 124 in the main area 111 of the memory device 110 to retain data consistency. The above-described operation is called a flush operation.

In a conventional cache scheme, which does not use a cache translation layer, a time to store file data in the memory system 110 may be relatively long. The memory system according to an exemplary embodiment of the present invention uses the FTL 125 (refer to FIG. 1) in order to reduce a time taken to write file data during a flush operation.

Referring to FIG. 3, a memory system 100b according to an exemplary embodiment of the present invention may include a cache translation layer (CTL) 125. The CTL 125 may manage an operation where file data of the cache memory 124 is dumped into the cache area 112 of the memory device 110 during a flush operation. The dump or flush operation is used by the CTL 125 to request the cache memory 124 to move all data to the cache area 112. The CTL 125 may manage an address mapping table associated with a dump operation.

As illustrated in FIG. 3, the memory system 100b according to an exemplary embodiment of the present invention uses the CTL 125 to sequentially store file data of the cache memory 124 in the cache area 112 of the memory device 110 during the flush operation. It is possible to reduce a time taken to store file data of the cache memory 124 in the memory device 110 during the flush operation as compared to the conventional cache scheme.

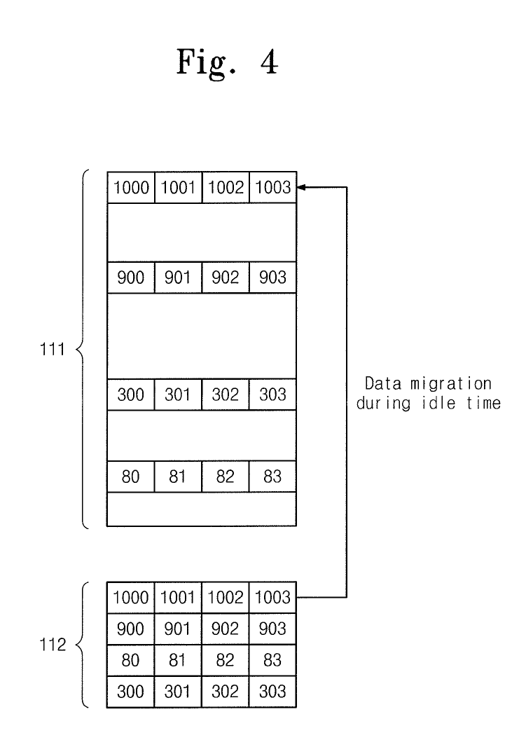

FIG. 4 is a conceptual diagram showing data migration according to a cache scheme of FIG. 3. A memory system 100 according to an exemplary embodiment of the present invention may store file data in a cache area 112 of a memory device 110 during a flush operation, and transfer file data of the cache area 112 into a main area 111 of the memory device 110 during an idle time. This operation is called data migration. With data migration, file data may be stored at a physical address of the main area 111. During the idle time, the memory system according to an exemplary embodiment of the present invention may prepare for an operation of the memory system to be performed layer. The preparation operation of the memory system is called a background operation. In an exemplary embodiment of the present invention, data migration can be performed during the background operation.

Herein, an operation of moving data from the cache area 112 to the main area 111 may be performed by various manners. For example, an operation of moving data from the cache area 112 to the main area 111 may commence according to whether the remaining capacity of the cache area 112 is below a predetermined capacity (e.g., 30%). Alternatively, an operation of moving data from the cache area 112 to the main area 111 may commence periodically. Alternatively, as illustrated in FIG. 4, an operation of moving data from the cache area 112 to the main area 111 may commence by sensing an idle time of the memory device 110.

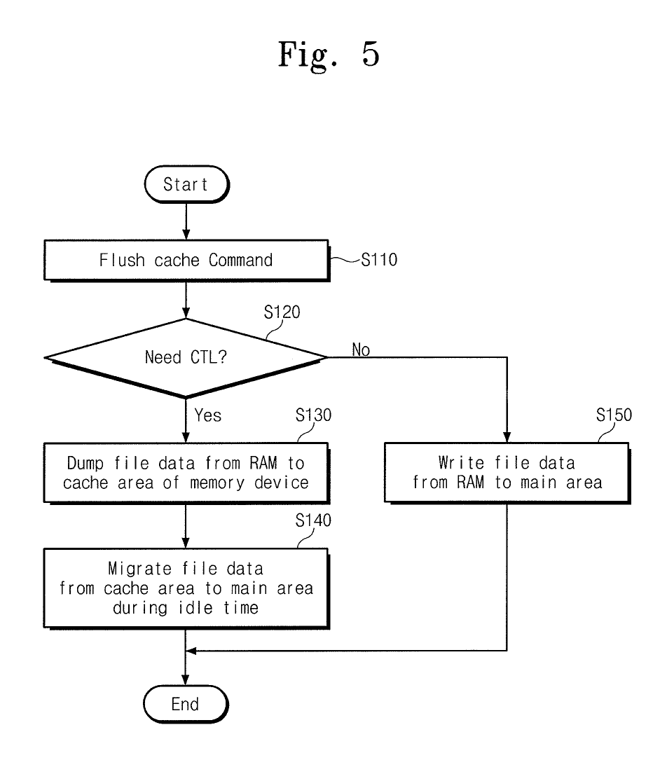

FIG. 5 is a flow chart for describing an operation of a memory system according to an exemplary embodiment of the present invention. A flush operation of a memory system according to an exemplary embodiment of the present invention is described with reference to FIGS. 1 and 5.

At block S110, a host (not shown) may provide a flush cache command to a memory system 100 (refer to FIG. 1). The memory system 100 may perform a flush operation in response to the flush cache command.

At block S120, a memory controller 120 (refer to FIG. 1) may judge whether a cache translation layer (CTL) is needed. The CTL may manage a cache area 112 of a memory device 110 (refer to FIG. 1) regardless of a flash translation layer (FTL). The CTL may manage the cache area 112 at an upper level as compared with the FTL.

If the CTL is needed, at block S130 a cache scheme described in FIG. 3 is performed. On the other hand, if the CTL is not needed, at block S150 a conventional cache scheme described in FIG. 2 is performed.

At block S130, the memory controller 120 responds to the flush cache command to dump file data of the cache memory 124 into the cache area 112 of the memory device 110. Herein, the memory controller 120 may sequentially store file data of the cache memory 124 in the cache area 112 to reduce a write time.

At block S140, the memory device 110 may transfer file data of the cache area 112 into a physical address of the main area. The memory system 100 may change a random write operation into a sequential write operation by use of the cache translation layer 125.

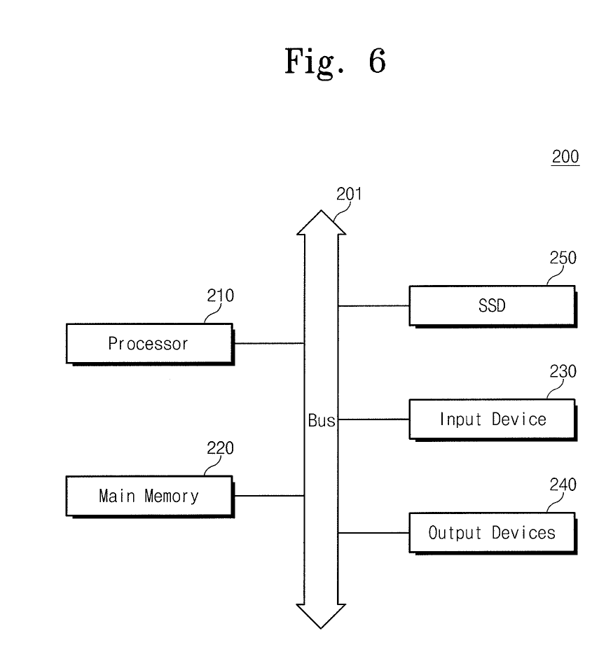

FIG. 6 is a schematic block diagram showing a computing system including a solid state disk according to an exemplary embodiment of the present invention. Referring to FIG. 6, a computing system 200 may include a processing unit 210, a main memory 220, an input device 230, output devices 240, and a memory system 250, which are connected electrically with a bus 201. FIG. 6 shows an example where the memory system 250 is embodied as SSD.

The processing unit 210 may include one or more microprocessors. The input and output devices 230 and 240 of the computing system 200 are used to input and output control information to or from users. The processing unit 210, the main memory 220, the input device 230, and the output devices 240 are electrically connected to a bus 201.

The computing system 200 may further comprise SSD 250, which operates according to an exemplary embodiment of the present invention and enables a host, such as the processing unit 210, to perform a write operation with a memory device 110 (refer to FIG. 1) in a fast access time. The memory device 110 of FIG. 1 may be embodiment as the SSD 250 of FIG. 6, and description thereof is thus omitted.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A memory system comprising:
a memory device having a cache area and a main area; and
a memory controller configured to control the memory device,
wherein the memory controller is configured to dump file data into the cache area in response to a flush cache command.

2. The memory device of claim 1, wherein the memory device moves file data of the cache area into the main area.

3. The memory device of claim 1, wherein the cache area and the main area are formed in one memory device.

4. The memory device of claim 3, wherein the cache area comprises a plurality of memory cells, the memory cells store single-bit data.

5. The memory device of claim 3, wherein the main area comprises a plurality of memory cells, the memory cells store multi-bit data.

6. The memory device of claim 1, wherein the cache area and the main area are formed of separate memory devices.

7. The memory device of claim 6, wherein the cache area comprises a plurality of memory cells, and the cache area is formed of a non-volatile memory storing single-bit data in the memory cells.

8. The memory device of claim 6, wherein the main area comprises a plurality of memory cells, and the main area is formed of a non-volatile memory storing multi-bit data in the memory cells.

9. The memory device of claim 1, wherein the memory device moves file data of the cache area into a physical address of the main area during an idle time.

10. The memory device of claim 1, wherein the memory device is solid state disk.

11. The memory device of claim 1, wherein the memory controller includes a cache translation layer for managing the cache area of the memory device.

12. The memory device of claim 11, wherein the cache translation layer manages a mapping table of the cache area during a flush operation.

13. The memory device of claim 11, wherein the memory controller includes a cache memory for storing the file data.

14. A data storing method of a memory system which comprises a memory device having a cache area and a main area and a memory controller configured to control the memory device, the data storing method comprising:
dumping file data into the cache area of the memory device in response to a flush cache command; and
moving the file data of the cache area into the main area.

15. The data storing method of claim 14, wherein the cache area comprises a plurality of first memory cells, and the cache area stores single-bit data in the first memory cells, and the main area comprises a plurality of second memory cells, and the main area stores multi-bit data in the second memory cells.

16. The data storing method of claim 14, wherein the memory device moves file data of the cache area into a physical address of the main area during an idle time or background operation.

17. The data storing method of claim 14, wherein the memory device is solid state disk.

18. The data storing method of claim 14, wherein the memory controller includes a cache translation layer for managing the cache area of the memory device.

19. The data storing method of claim 18, wherein the cache translation layer manages a mapping table of the cache area during a flush operation.
